(19) United States
(12) Patent Application Publication
(10) Pub. No.: US 2023/0173711 A1
(43) Pub. Date: Jun. 8, 2023

(54) Reel-to-Reel Fabrication of Coated Threads

(71) Applicant: Trustees of Tufts College, Medford, MA (US)

(72) Inventor: Sameer Sonkusale, Lincoln, MA (US)

(21) Appl. No.: 17/916,294

(22) PCT Filed: Mar. 25, 2021
(86) PCT No.: PCT/US2021/024085

§ 371 Date: Sep. 30, 2022

Related U.S. Application Data
(60) Provisional application No. 63/004,042, filed on Apr. 2, 2020.

(51) Int. Cl. B29B 15/12; D02G 3/36; D02G 3/40

(52) U.S. Cl. CPC B29B 15/125; D02G 3/36; D02G 3/404

(57) ABSTRACT

In an apparatus for manufacturing a coated thread, a thread extends between first and second spools and passes through a cartridge having ink reservoirs in which the stretched thread is dipped while the thread and a sensor that provides, to a controller, a value of a parameter indicative of an extent to which the thread has been dipped in the ink reservoir. The controller uses this parameter as a basis for controlling rotation of a motor that rotates one of the spools.

### RELATED APPLICATIONS

This application claims the benefit of the Apr. 2, 2020 priority date of U.S. Provisional Application 63/004,042, the contents of which are incorporated herein by reference.

### STATEMENT OF GOVERNMENT SUPPORT

This invention was made with government support under grant W911QY-15-2-0001 awarded by the United States Army and grant N00014-16-1-2550 awarded by the United States Navy. The government has certain rights in the invention.

### FIELD OF INVENTION

This invention pertains to device integration, and in particular, to integration of devices that can be worn or implanted.

### BACKGROUND

As a result of advances in miniaturization and device integration, it is now possible to have wearable sensors that provide data about the wearer more or less continuously or on demand. These sensors can be worn outside the body, in which case they are often called “smart wearable systems.” They can also be worn inside the body. In such cases, they are often called “implantable diagnostic devices.”

The devices themselves are typically integrated into a two-dimensional manifold. In some cases, the manifold is a rigid planar structure, in which case devices cannot move relative to each other. However, in many cases, the devices are integrated into a flexible two-dimensional manifold. Smart clothing, in which devices are disposed on a flexible fabric, provides an example of this.

The construction of such devices relies in part on threads that have been coated or impregnated with a material in which continuity of the material is important. For example, in a conductive thread, it is important that the conductive material maintain continuity. Because the thread flexes during use, there exists a risk that discontinuities will arise during use.

### SUMMARY

The invention concerns the manufacture of threads for use in a variety of applications such as flexible and wearable medical and consumer devices. Such devices include biosensors for use in biomedical diagnostics and health monitoring. Applications outside the medical fields include wearable devices incorporating such threads for human-machine interactions, for instance as an input device.

The invention provides a reel-to-reel fabrication method to create functionalized threads. Examples of such threads include sensing threads for sensing strain and sensing presence of certain chemicals. The fabrication method promotes the ability to create threads having uniform properties along the length of the thread and to have an easily adjustable thickness during manufacture. Using such a method, it is possible to fabricate composite threads having two or more constituents.

In one aspect, the invention features a scalable reel-to-reel fabrication process for making strain-sensitive threads. Such a method includes pre-stretching the threads, dip coating the pre-stretched threads with conductive inks using a cartridge, and drying the threads in a heated chamber.

In one aspect, the invention features an apparatus for manufacturing a coated thread. Such an apparatus includes a cartridge, a sensor, a first motor, and a controller. During operation, the thread extends between first and second spools and passes through the cartridge and the sensor. Within the cartridge, the thread is stretched while traversing a path through the cartridge. The cartridge includes ink reservoirs in which the thread is dipped while it is stretched. The sensor provides, to the controller, a value of a parameter that indicates an extent to which the thread has been dipped in the ink reservoir. The first motor rotates one of the first and second spools. The controller controls rotation of the first motor in response to the value of that parameter as received from the sensor.

In some embodiments, the cartridge includes first and second windows, a ceiling, a floor, first ridges that protrude into an interior of the cartridge from the ceiling, and second ridges that protrude into the interior from the floor. The first and second ridges cooperate to guide the thread along the path while the thread is dipped into ink that has collected in reservoirs formed by the second ridges. Among these are embodiments are those in which the first and second ridges interdigitate, those in which first and second ridges have semi-circular cross sections, and those in which the first window is a window that engages a segment of the thread that is within the cartridge is stretched.

Among the embodiments are those in which the window is a polymer window. Embodiments include those in which the polymer includes a thermoplastic polymer and those in which it includes a thermoplastic elastomer. Also among the embodiments are those in which the polymer is any one of a polycarbonate, PDMS, a polyamide, PMMA, PVA, PLGA, ABS, nylon, PEEK, and PTFE as well as those in which it is a 3D-printed resin. Also among the embodiments are those in which the polymer is a thermoplastic polyolefin elastomer or a thermoplastic polyurethane.

Among the embodiments are those in which the path is a sinuous path, those in which it is a triangular path, those in which it is an undulating path, and those in which it is a meandering path. Also among the embodiments are those in which, at each point on the path, there exists a tangent line having a slope. The slope is positive along a first portion and negative along a second portion of the path. These portions meet at a location on the path at which the slope is zero.

In some embodiments, the sensor is configured to sense conductivity of a segment of the thread. Among these are embodiments in which the sensor has rods separated by a gap that defines an extent of the segment.

Some embodiments feature a second motor. In these embodiments, the first and second motors rotate corresponding ones of the first and second spools. Among these are embodiments in which the controller drives the first and second motors at different speeds and those in which the controller adjusts first and second speeds at which the motors are driven so as to reduce a measured variation in the value. In some embodiments, the controller carries out closed-loop feedback. Among these are embodiments in which the controller monitors tension in the thread and controls motor speeds in a way that maintains a desired tension.

In another aspect, the invention features a method that includes manufacturing a coated thread by stretching the thread while simultaneously dipping the thread into ink that is held in ink reservoirs. The method further includes, after the thread has been dipped, measuring a value of a parameter, the value being indicative of an extent to which the thread has been dipped in the ink reservoirs, and controlling movement of the thread through the ink reservoirs based at least in part on the value.

Among the practices are those in which the value is indicative of thread resistivity, those in which it is indicative of capacitance per unit length, those in which it is indicative of conductivity, those in which it is indicative of impedance per unit length, those in which it is indicative of admittance per unit length, and those in which it is indicative of inductance per unit length.

Also among the practices are those that in which the thread is simultaneously dipped into ink in ink reservoirs while being made to follow a path between first ridges and second ridges, the second ridges being interdigitated between the first ridges. In such practices, pairs of ridges form the ink reservoirs between them. Among these practices are those that include causing the thread to follow a sinuous path, a triangular path, an undulating path, or a meandering path. Also among these practices are those in which, at each point on the path, there exists a tangent line having a slope that is positive along a first portion of the path and negative along a second portion of the path. These portions meet at a location on the path at which the slope is zero. Also among these practices are those that include guiding the thread along a path having plural semicircular path sections.

Further practices are those that include passing the thread through a polymer window that engages a segment of the thread that is within the cartridge is stretched. Among these are practices that include selecting the polymer to comprise a thermoplastic polymer, selecting the polymer to comprise thermoplastic elastomer, selecting the polymer from the group consisting of a polycarbonate, PDMS, a polyamide, PMMA, PVA, PLGA, ABS, nylon, PEEK, and PTFE, selecting the polymer to comprise a 3D-printed resin, and selecting the polymer to comprise one of a thermoplastic polyolefin elastomer and a thermoplastic polyurethane.

Yet other practices feature receiving the thread from the cartridge after the thread has been dipped into the ink and drying the thread.

Also among the practices are those in which measuring a value of a parameter includes measuring a value indicative of resistivity of the thread and those that include using the value to control movement of the thread so as to reduce a measured variation in the value.

Additional practices include those in which the measurement includes measurement of a value indicative of capacitance, inductance, or impedance per unit length of the thread.

The integration of sensors into daily wear, such as shoes or clothing, has the potential to revolutionize healthcare and fitness. The method and systems disclosed herein disclose a way to fabricate strain-sensing thread in a scalable manner by using a reel-to-reel fabrication method.

In some examples, the fabrication includes coating of bare threads with conductive ink. This is carried out using a cartridge that enables simultaneous stretching and dip coating, followed by drying the coated thread in a heated chamber. A simple way to construct such a cartridge is by additive manufacturing, which is sometimes referred to as three-dimensional printing.

It has been found to be particularly useful to pre-stretch thread before dip coating. Doing so promotes conductivity and strain measurement even under extreme stretching conditions. Suitable strain sensitive threads are made from coating of carbon ink on elastic threads.

Flexible sensors and electronics as described herein are suitable for real-time health monitoring through non-obtrusive continuous measurement of vital signs such as electrical activity of the heart of the type observed by an electrocardiogram and respiration rate. Such sensors incorporate sensing and electronic functionality directly into the multi-filament yarns or threads that make up clothing. Examples include accessories, sensors, transistors, integrated circuits, and antennas that have been directly integrated on to clothing.

A scalable bottom-up approach for making flexible textile-based platforms relies on fabrication of individual functionalized smart threads that are then sewn or stitched on to flexible and elastomeric polymers along with other smart threads to realize a complete thread-based wearable platform.

A suitable method for making such threads is based on dip coating and drying to infuse textile threads with variety of micro-materials and nano-materials to endow these threads with physical, chemical, and mechanical attributes. The approach is scalable to any thread type and enables coatings with different materials. The process allows threads to acquire unique properties. Such properties include physical, biological, and mechanical properties. Examples of physical properties include wettability and thermal insulation. Examples of biological properties include biocompatibility and antibacterial properties.

In some embodiments, smart threads are incorporated directly into tissues as sutures or sewn onto conventional bandages to perform real-time monitoring of wounds. Among these are embodiments in which the smart threads are used to in connection with releasing substances, such as drugs, and in particular, doing so in a temporally or spatially controlled manner. This includes releasing a particular substance at a particular location at a particular time.

The methods and systems described herein describe a scalable reel-to-reel fabrication process for making strain-sensitive threads by dip coating pre-stretched threads with conductive ink using a novel cartridge designed for combined pre-stretching and dip coating. This results in a homogeneous smart thread. The coating process is followed by controlled drying in a heated chamber. In some embodiments, a strain sensitive thread comprises an elastic thread coated with carbon. A suitable elastic thread is a 12-gauge thread.

The embodiments described herein include imparting strain sensitivity to natural stretchable threads by causing the thread to change electrical resistance in response to strain. This is achieved by dip-coating threads with conductive carbon ink. In a thread that has been thus coated, stretching changes the length and density of the conductive layer, thus providing a basis for changing an electrical parameter in response to strain. Although it is possible to manually dip the threads, doing so often results in threads with varying electrical or mechanical properties due to process variations. The methods and systems described herein provide threads having a uniform carbon coating with that respond to strain in a similar manner provided that the threads were coated under similar conditions.

The methods and systems described herein carry out dip coating of pre-stretched threads with conductive ink followed by drying in a controlled manner. Some embodiments repeat this process with different inks. This results in fabrication of layered composite threads.

The pre-stretching of threads before dip coating is particularly useful. Pre-stretching reduces the incidence of fracturing and cracking of the conductive layer in the finished thread. This reduces the possibility of losing connectivity altogether under extreme stretching. The apparatus described herein features an ink-loaded cartridge that simultaneously stretches and dip-coats the thread.

These and other features of the invention will be apparent from the following detailed description and the accompanying figures, in which:

### BRIEF DESCRIPTION OF THE FIGURES

FIG. 1 shows a reel-to-reel apparatus for fabricating a coated thread;

FIG. 2 shows a cross-section of the cartridge shown in FIG. 1;

FIG. 3 shows details of the sensor shown in FIG. 1; and

FIG. 4 shows an embodiment of circuitry for control of the apparatus shown in FIG. 1.

### DETAILED DESCRIPTION

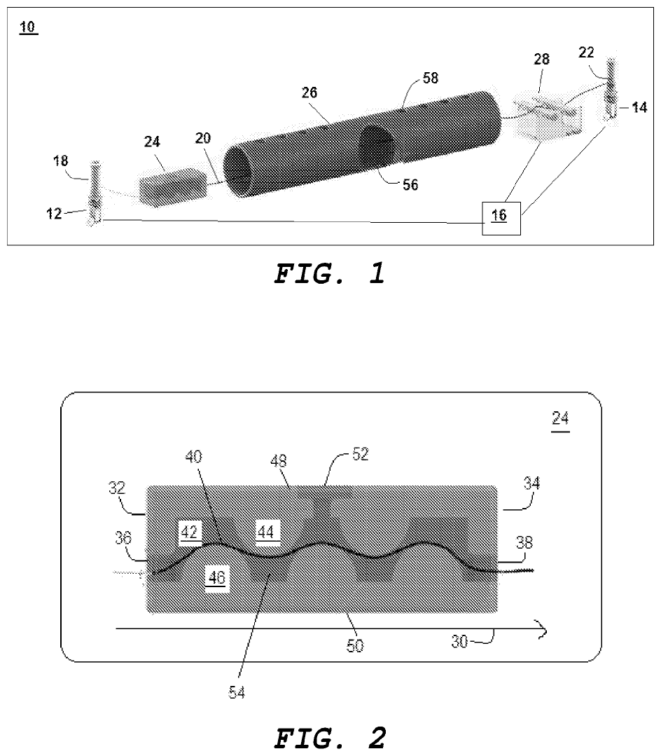

FIG. 1 shows an apparatus 10 that features first and second DC motors 12, 14 that are adaptively driven by a controller 16. The first motor 12 couples to a first spool 18 on which is wound an elastic thread 20 that is to be processed. The second motor 14 couples to a second spool 22 that takes up the thread 20 after it has been processed. Together, the first and second motors 12, 14 cooperate to move the thread 20 downstream from the first spool 18 to the second spool 22.

In some embodiments, a suitable motor 12, 14 is a 12-volt DC motor sold under the name “MINI METAL GEAR” and made by MAKEBLOCK of Santa Ana, Calif.

In some embodiments, the thread 20 is an elastic thread that comprises a combination of polyester and polyurethane. In a particular embodiment, the thread 20 is 64% polyester and 36% polyurethane. A suitable thread is one made in Germany and sold under the name “GÜTERMANN.” A spool comprising such a thread 20 is mounted on the DC motor 12.

On its way between the first and second spools 18, 22, the thread 20 passes through a cartridge 24, a dryer 26, and a sensor 28.

FIG. 2 shows a cross section of the cartridge 24 in FIG. 1.

The cartridge 24 extends along an axis 30 from an upstream end 32 to a downstream end 34. The upstream end 32 has an upstream window 36 formed therein. The downstream end 34 has a downstream window 38 formed therein.

In some embodiments, the upstream and downstream windows 36, 38 are mode of a cured polydimethylsiloxane, such as that manufactured by DOW CORNING of Auburn, Mich. with a 10:1 weight ratio of elastomer to curing agent. The polydimethylsiloxane pre-stretches the thread 20, thus promoting the ink's ability to penetrate its fibrous texture.

Each of the upstream and downstream windows 36, 38 is formed from a polydimethylsiloxane membrane having an aperture through which the thread 20 passes. These apertures are small enough so that the thread 20 engages the walls of these apertures as it passes through the cartridge 24. As a result, the thread 20 has a stretched segment 40 that extends between the upstream and downstream windows 36, 38.

As can be seen in FIG. 2, the cartridge's interior 42 is defined by upper and lower ridges 44, 46. The upper ridges 44 protrude downward from an upper surface 48 of the cartridge 24. Similarly, the lower ridges 46 protrude upward from a lower surface 50 of the cartridge 24. In the illustrated embodiment, each ridge 44, 46 is a semi-cylindrical structure that extends transverse to the axis 30. Accordingly, the cross-sections are semicircular as shown in FIG. 2.

The upper and lower ridges 44, 46 are displaced along the axis 30 to an extent that allows them to interdigitate. As a result, the upper and lower ridges 42, 44 both guide the thread 20 along a sinuous path as it travels across the cartridge 24 and cooperate in maintaining the thread 20 in a stretched state.

The upper surface 48 of the cartridge 24 features an injection window 52 through which an ink can be injected into the cartridge's interior 42.

As used herein, an “ink” is a combination of a carrier and a functional ingredient that is left behind in the thread after the carrier has evaporated. Unlike inks used in writing, the residue is generally not a pigment.

The ink is applied to the thread 20 to enable the thread 20 to achieve its intended function. For example, when manufacturing a conductive thread 20 such as that used to detect strain, the residue left behind by the ink is what endows the thread 20 with the necessary conductivity. In the case of a thread 20 that is intended to detect a chemical, the residue left by the ink is what endows the processed thread with the ability to detect that chemical.

This ink collects in spaces between adjacent lower ridges 46. These spaces thus define reservoirs 54. The upper ridges 44 guide the thread 20 downward. This permits the ink and the thread 20 to comingle in the reservoirs 54. With the thread 20 also having been stretched, the interstitial spaces between the filaments that make up the thread are expanded. This enables them to take up the ink more efficiently and in a more uniform manner, thereby reducing variability of the thread's functional properties along the length of the thread 20.

The ridges 42, 44 thus support sliding of the thread 20 while promoting adhesion of ink on the thread 20. Additionally, each ridge 42, 44 exerts pressure on the thread in a direction that urges the thread 20 towards an ink reservoir 54. This promotes reliable dipping of the thread 20 into the ink. The number of ridges 42, 44 is adjustable to promote reliability of the coating process.

By ensuring that the thread 20 is stretched while it is taking up the ink, it is possible to reduce the risk of fracturing and cracking of a functional residue left behind by the ink once it has dried. This risk arises when the thread 20 is being stretched while in use. For example, in the case of a conductive ink, fracturing and cracking of the thread's conductive layer contributes to loss of connectivity.

In the illustrated embodiment, only two reservoirs 54 have been formed. However, additional reservoirs 54 can be formed by increasing the number of ridges 44, 46. In such cases, it may be necessary to have additional injection windows 52. These additional reservoirs 54 promote more reliable dipping of the thread 20 into the ink.

Upon having been dipped into ink, the thread 20 proceeds into the dryer 26. The dryer 26 includes an inlet 56 for admitting hot air and outlets 58 on an upper side thereof through which hot air laden with carrier vapor exits the dryer 26. As the thread moves through the dryer, the carrier evaporates, leaving behind a uniform solidified coating of residue on the thread 20.

A suitable heat source for the dryer 26 is a commercial hair dryer. In some practices, the hair dryer is sold under the name “MODEL 1035” by “HOT TOOLS PROFESSIONAL IONIC” in China. This hair dryer provides a temperature of about 80° C. inside the dryer 26. As the thread moves through the dryer 26, the solvent from carbon coating on the thread evaporates, leaving behind a uniform solidified carbon coating on the thread 20.

Upon exiting the dryer 26, the dried thread 20 enters the sensor 28. The sensor 28 provides a basis for determining how effectively the thread 20 was coated while in the cartridge 24. The details of the sensor 28 thus depend a great deal on the nature of the residue.

In some embodiments, the sensor 28 carries out a real-time resistance measurement as thread 20 exits the dryer 26. Among these are embodiments in which two metal rods 78, 80 are placed on a holder to measure the resistance of a length of thread 20 between them. The controller 16 controls this resistance measurement. A suitable controller 16 is a microcontroller such as an “ARDUINO NANO” microcontroller.

In one embodiment, the residue is that of a carbon ink that is intended to impart conductivity to the thread 20. In such embodiments, the sensor 28 is configured to measure resistivity.

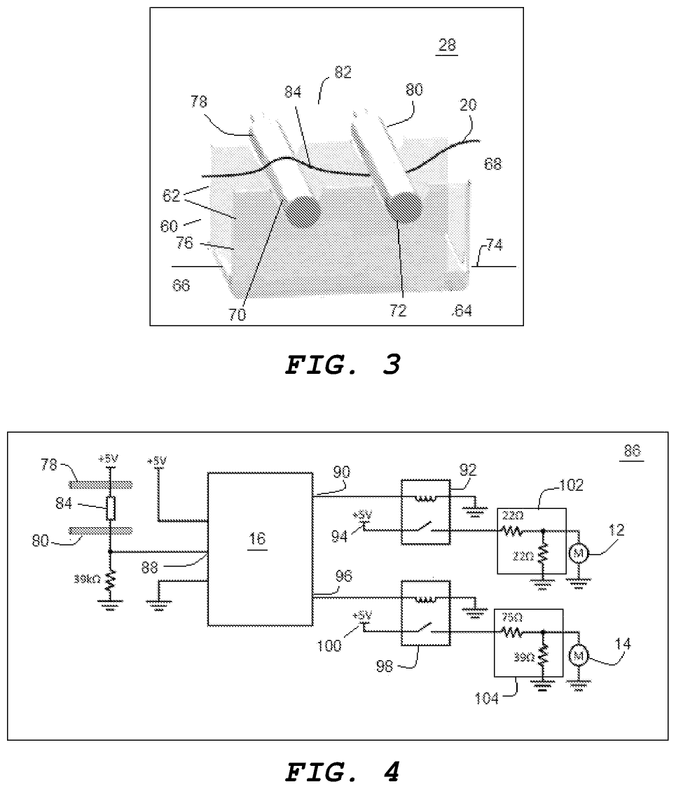

Referring now to FIG. 3, a sensor 28 for real-time measurement of the thread's resistivity as it is being manufactured features a support 60 having first and second parallel walls 62, 64 extending upward from a base 66. Each wall 62, 64 has an upper free edge 68 that has first and second cut-outs 70, 72 separated along the support's longitudinal axis 74, thus defining a transverse gap 76. The cut-outs 70, 72 of each wall 62, 64 are aligned so as to cradle corresponding first and second rods 78, 80 that extend across the transverse gap 76. The separation between the first and second rods 78, 80 defines a longitudinal gap 82. A suitable gap 82 is about two centimeters.

In some experiments, real-time measurement of the resistance using the first and second rods 78, 80 separated by two centimeters showed a variability between 1.56 kΩ to 2.42 kΩ, with an average of 1.94 kΩ. This is significantly lower than manual dipping, in which variations range from 1 kΩ to 20 kΩ.

In operation, the thread 20 extends along the support's longitudinal axis 74 and contacts the first and second rods 78, 80. As a result, there exists a segment 84 of thread 20 between the first and second rods 78, 80. By applying a voltage between the first and second rods 78, 80, it is possible to create a voltage across the segment 84. The resulting current, combined with the known extent of the longitudinal gap 82, provides a basis for measuring the thread's resistivity in real time. The value of this resistivity depends in part on the operation of the first and second motors 12, 14. As a result, the controller 16 uses this resistivity as a feedback signal for controlling the first and second motors 12, 14.

Although the first and second motors 12, 14 start together, they are not continuously operated. This is because doing so may cause the initial pre-stretching of the thread 20 to gradually be lost.

In particular, continuous operation promotes high-speed sliding that risks a progressive loss of the mechanical pre-stretch that the thread 20 had earlier been endowed with. As a result, it is useful to control operation by alternately turning the motors 12, 14 on and off. A suitable solution is to have the motors be turned on for two hundred milliseconds and to turn them off for eight hundred milliseconds. Cycling the motors 12, 14 in this manner is among the functions of the controller 16.

In some embodiments, the controller 16 implements real-time feedback control by monitoring the thread's tension and adjusting motor operation accordingly.

The first and second motors 12, 14 carry out different functions and therefore require different controlling methods. The second motor 14 collects the coated thread 20 while also forcing it to exit from the cartridge 24. The second motor 14 thus exerts considerable pulling force. The first motor 12, on the other hand, operates primarily to control the mechanical tension of the thread 20 as it enters the cartridge 24. Although it does not pull, the first motor's rotation can be used to balance the second motor's pull. This prevents the thread 20 from sliding abruptly starting and stopping as it moves through the cartridge 24. By causing the first and second motors 12, 14 to cooperate, the controller 16 causes the thread 20 to move smoothly and continuously through the cartridge 24.

The ideal rotation speeds of the first and second motors 12, 14 are arrived at empirically based on the required tension in the thread 20 as it makes its way through the cartridge 24. Although some drift in the thread's tension tends to occur over time, for short runs, the accumulated drift is not enough to impair the consistency of the thread's coating.

FIG. 4 shows circuitry 86 used for controlling the first and second motors 12, 14. Also shown in FIG. 4 are the first and second rods 78, 80 with the segment 84 therebetween represented as a resistor of unknown resistance. The segment 84, together with a resistor of known resistance, forms a voltage divider that has a known voltage, which in the illustrated embodiment is five volts, applied across it.

The controller's analog input 88 connects to the midpoint of the voltage divider, thus providing a basis for determining the voltage across the segment 84.

The controller's first output 90 operates a first relay switch 92 that selectively connects and disconnects a first voltage source 94 from the first motor 12. The controller's second output operates a second relay switch 98 that selectively connects and disconnects a second voltage source 100 from the second motor 14.

The controller's first and second outputs 90, 96 provide pulses to operate that are about two hundred milliseconds long and occur at intervals of about one second. The controller 16 adjusts these values in real time based on the measurement from its analog input 88.

For those embodiments in which the first voltage source 94 would cause the first motor to spin too fast, it is useful to provide a first voltage divider 102 between the first voltage source 94 and the first motor 12. Similarly, for those embodiments in which the second voltage source 100 would cause the second motor 14 to spin too fast, it is useful to provide a second voltage divider 104 between the second voltage source 100 and the second motor 14.

In the illustrated embodiment, the five volts provided by the first and second voltage sources 94, 100 would result in excessive rotation speed. The first and second voltage dividers 102, 104 thus bring the rotation speed to a more manageable twenty to eighty revolutions per minute.

As is apparent from FIG. 4, the first and second voltage dividers 102, 104 have different configurations. This results in the first and second motors 12, 14 having slightly different operating speeds. These differing speeds are the result of the motors' different functions as described above.

An embodiment as described herein permits about twenty centimeters of thread 20 to be manufactured in one minute. Thread lengths of about one meter have been manufactured without significant impairment of resistivity that results from accumulated drift.

In the embodiment described herein, measurement of thread resistivity permits real-time monitoring of the coating process. In alternative embodiments, the feedback relies on closed-loop feedback control using a PI or PID controller.

The first and second motors 12, 14 are identical but perform different functions. This difference in function requires that the controller control them differently.

The second motor 14, which is downstream of the dryer, collects thread 20. This includes pulling on the thread 20 to promote its exit from the cartridge 24.

On the other end, the first motor 12 manages mechanical tension of the thread 20 as it enters the cartridge 24. Therefore, the first motor 12 does not pull like the second motor 14. Instead, the first motor 12 uses its rotation to balance the second motor's pull in an effort to prevent the thread from sliding. The relative rotation speeds of the first and second motors 12, 14 is therefore determined empirically based on the required tension in the thread 20 as it passes through the cartridge 24.

As a result, although the controller 16 pilots both motors 12, 14 in a similar way, there are some differences that arise from the motors' differing functions. First the actual DC biasing of a motor 12, 14 is set based on its required rotation speed. In the embodiment shown, a five-volt bias results in a high rotation speed. For this reason, a voltage divider is used to apply an appropriate voltage to adjust the rotation speed set in the range of 20-80 rpm. Second, the speed of operation of two motors is not the same.

In the illustrated embodiment, the differing bias applied to the first and second motors 12, 14 results in an eventual drift in the thread's tension. As a result, only a limited amount of thread 20 can be produced before the drift becomes excessive. Using the illustrated apparatus, it is possible to make as much as a meter of thread per batch at a rate of about twenty centimeters per minute. However, an alternative embodiment that uses closed-loop feedback such as using PI or PID for feedback control, would be able to make thread 20 indefinitely.

In the illustrated embodiment, only one cartridge 24 is shown. However, it is possible to incorporate additional cartridges in series. This permits application of different materials on the same thread 20, thus forming a layered composite thread. Cartridges of various shapes and sizes are easily manufactured by 3D printing using a high-temperature resin.

A variety of inks can be used. Among these are dielectric inks such as silicone, siloxane, including PDMS, and ecoflex. Embodiments also include the use of semiconducting inks. Such inks are made by dispersions of either semiconducting nanotubes, silicon nanowires, zinc oxide nanowires, amorphous silicon, indium gallium zinc oxide, semiconducting carbon nanotubes, graphene flakes, MoS₂ flakes, WS₂, WSe₂, MoTe₂, MoSev, and reduced graphene oxide. In some embodiments, the ink is a C-200 carbon resistive ink supplied by APPLIED INK SOLUTIONS of Westborough, Mass.

In some embodiments, the ink reservoir 54 within the cartridge 24 holds chemical sensing dyes that can be used to give the threads the ability to change color upon exposure to various chemicals, whether in gaseous or liquid form. Examples of such dyes include pH responsive dyes, such as methyl red and bromothymol blue, solvatochromic dyes, such as Nile red etc., metalloporphyrinns, such as Zn(TPP), Mn(TPP), and Reichardts dye.

In some embodiments, the ink reservoir 54 within the cartridge 24 holds mixtures of two or more of the foregoing the inks in different concentrations to form hybrid composite inks.

As discussed above, it is possible to use cartridges 24 in series. In such cases, the cartridges use the same ink. This results in a thicker coat of that ink. However, in other cases, the result is a thread that is coated with layers of different inks. Among these are embodiments in which the first cartridge 24 holds conductive ink and a subsequent cartridge holds dielectric ink. These embodiments manufacture a thread having an inner conductive coating and an outer dielectric coating.

Also among these are embodiments in which the first cartridge 24 holds a conductive ink, a second cartridge that follows the first cartridge holds a semiconducting ink, and a third cartridge that follows the second cartridge holds a dielectric ink. These embodiments manufacture a thread having an inner conductive coating, an outer dielectric coating, and an intermediate semiconducting coating between the inner and outer coatings.

Having described the invention and a preferred embodiment thereof, what is claimed as new and secured by Letters Patent is:

1. An apparatus for manufacturing a coated thread, said apparatus comprising a cartridge, a sensor, a first motor, and a controller, wherein, in operation, said thread extends between first and second spools and passes through said cartridge and said sensor, wherein, as a result of a path through which said thread passes through said cartridge, said thread is stretched while passing through said cartridge, wherein said cartridge includes an ink reservoir in which said thread is dipped while said thread is stretched, wherein said sensor provides, to said controller, a value of a parameter, said value being indicative of an extent to which said thread has been dipped in said ink reservoir, wherein said first motor rotates one of said first and second spools, and wherein said controller controls rotation of said first motor in response to said value.

2. The apparatus of claim 1, wherein said cartridge comprises first and second windows that open into an interior of said cartridge, a ceiling, a floor, first ridges that protrude into said interior from said ceiling, second ridges that protrude into said interior from said floor, wherein said first and second ridges cooperate to guide said thread along said path during which said thread is dipped into ink that has collected in reservoirs formed by said second ridges.

3. The apparatus of claim 1, wherein said path is a triangular path.

4. The apparatus of claim 1, wherein, at each point on said path, there exists a tangent line having a slope, wherein along a first portion of said path said slope is positive, wherein along a second section of said path, said slope is negative, and wherein said first and second sections meet at a location on said path at which said slope is zero.

5. The apparatus of claim 1, wherein said cartridge comprises first and second ridges that interdigitate and that define said path.

6. The apparatus of claim 1, wherein said cartridge comprises first and second ridges have semi-circular cross sections and that define said path.

7. The apparatus of claim 2, where said first window is a polymer window that engages a segment of said thread that is within said cartridge is stretched.

8. The apparatus of claim 2, wherein said first window comprises a thermoplastic polymer that engages a segment of said thread that is within said cartridge is stretched.

9-12. (canceled)

13. The apparatus of claim 1, further comprising a dryer for receiving said thread from said cartridge after said thread has been dipped into said ink.

14. The apparatus of claim 1, wherein said sensor is configured to sense resistivity of a segment of said thread and said value is indicative of said resistivity.

15. The apparatus of claim 1, wherein said sensor is configured to sense conductivity of a segment of said thread and said value is indicative of said conductivity.

16. The apparatus of claim 1, wherein said sensor is configured to sense impedance of a segment of said thread and said value is indicative of impedance per unit length of said thread.

17. The apparatus of claim 1, wherein said sensor is configured to sense admittance of a segment of said thread and said value is indicative of admittance per unit length of said thread.

18. The apparatus of claim 1, wherein said sensor is configured to sense capacitance of a segment of said thread and said value is indicative of capacitance per unit length of said thread.

19. The apparatus of claim 1, wherein said sensor is configured to sense inductance of a segment of said thread and said value is indicative of inductance per unit length of said thread.

20. The apparatus of claim 14, wherein said sensor comprises first and second rods separated by a gap and wherein said gap defines an extent of said segment.

21. The apparatus of claim 1, further comprising a second motor, wherein said first and second motors each drive one of said first and second spools.

22. The apparatus of claim 21, wherein said controller is configured to drive said first and second motors at different speeds.

23. The apparatus of claim 21, wherein said controller is configured to adjust first and second speeds at which said motors are driven so as to reduce a measured variation in said value.

24. A method comprising manufacturing a coated thread, said method comprising stretching said thread while simultaneously dipping said thread into ink in ink reservoirs, after said thread has been dipped, measuring a value of a parameter, said value being indicative of an extent to which said thread has been dipped in said ink reservoirs, and controlling movement of said thread through said ink reservoirs based at least in part on said value.

25-43. (canceled)
